(19) United States
(12) Patent Application Publication
(10) Pub. No.: US 2016/0140472 A1
(43) Pub. Date: May 19, 2016

(54) SYSTEMS AND METHODS FOR MANAGING ASSEMBLY ACCOUNTABILITY GRIEF

(71) Applicant: Caterpillar Inc., Peoria, IL (US)

(72) Inventors: Joseph R. HERRON, Farmington, IL (US); Yamin Z. MOHAMMED, Peoria, IL (US)

(73) Assignee: Caterpillar Inc., Peoria, IL (US)

(21) Appl. No.: 14/543,248

(22) Filed: Nov. 17, 2014

(51) Int. Cl. G06Q 10/06; G06F 17/30

(52) U.S. Cl. CPC G06Q 10/06316; G06F 17/30722

(57) ABSTRACT

Systems and methods are disclosed for managing assembly accountability grief. According to certain embodiments, a change that creates at least one grief is detected. An accountability report associating the at least one grief with an affected model is received. Moreover, the at least one grief may be assigned to a workcenter.

### TECHNICAL FIELD

The present disclosure generally relates to systems and methods for managing assembly accountability grief and, more particularly, to systems and methods for managing assembly accountability grief through improved reporting and assignment of grief.

### BACKGROUND

Modification to manufacturing processes can lead to inefficient consumption of components, which may generally be referred to as grief. There are several different causes for grief in manufacturing, including underconsumption, overconsumption, broken consumption, and invalid consumption of components. Grief leads to holdup in the manufacturing process because assembly cannot proceed without the proper allocation of components to be assembled. For example, if a component is unallocated from an assembly process and not reallocated elsewhere, the unallocated component may need to be applied to a worker and workcenter who may determine the proper allocation of the component. Grief should be resolved quickly (e.g., prior to releasing production orders), so that manufacturers do not experience down time in the assembly process.

Existing methods for resolving grief in the manufacturing process require manufacturing engineers to sift through large volumes of data to determine how properly to allocate materials to machines and/or processes. Several engineers may be dedicated to pulling together and analyzing the data needed to determine how to resolve the grief. Thus, these systems are costly for manufacturers in terms of both personnel and time.

One technique for managing the assignment of tasks is described in U.S. Patent App. Pub. No. 2007/0150327 (“the '327 application”). The '327 application describes techniques for associating both human and non-human resources with projects. For example, the '327 application considers the availability and utilization of human resources, as well as the plant, equipment and supplies that must be allocated to a task.

Although the '327 application discloses techniques for associating personnel and materials to tasks, it fails to provide details regarding the relationships between the personnel and materials. For example, the '327 application fails to disclose how the appropriate personnel may be determined for new and/or unassigned materials. Moreover, the '327 application does not explain how inefficiencies with respect to the consumption of materials can be resolved.

The present disclosure is directed to overcoming one or more of the problems set forth above and/or other problems in the art.

### SUMMARY OF THE INVENTION

In one aspect, the present disclosure is directed to a system for managing assembly accountability grief, including a memory that stores a set of instructions and at least one processor in communication with the memory and configured to execute the set of instructions to perform certain steps. The processor is configured to detect a change that creates at least one grief. The processor is further configured to receive an accountability report associating the at least one grief with an affected model. Moreover, the processor is configured to assign the at least one grief to a workcenter.

In another aspect, the present disclosure is directed to a non-transitory computer-readable storage medium storing instructions for managing assembly accountability grief. The instructions cause the at least one processor to perform operations including detecting a change that creates at least one grief. The operations further include receiving an accountability report associating the at least one grief with an affected model. Moreover, the operations include assigning the at least one grief to a workcenter.

### BRIEF DESCRIPTION OF THE DRAWINGS

FIG. 1 is an illustration of an exemplary system environment for managing assembly accountability grief;

FIG. 2 is a flow chart illustrating an exemplary disclosed method of managing assembly accountability grief;

FIG. 3 is another flow chart illustrating another exemplary disclosed method of managing assembly accountability grief; and

FIG. 4 is a flow chart illustrating an exemplary disclosed method of managing component control cycles.

### DETAILED DESCRIPTION

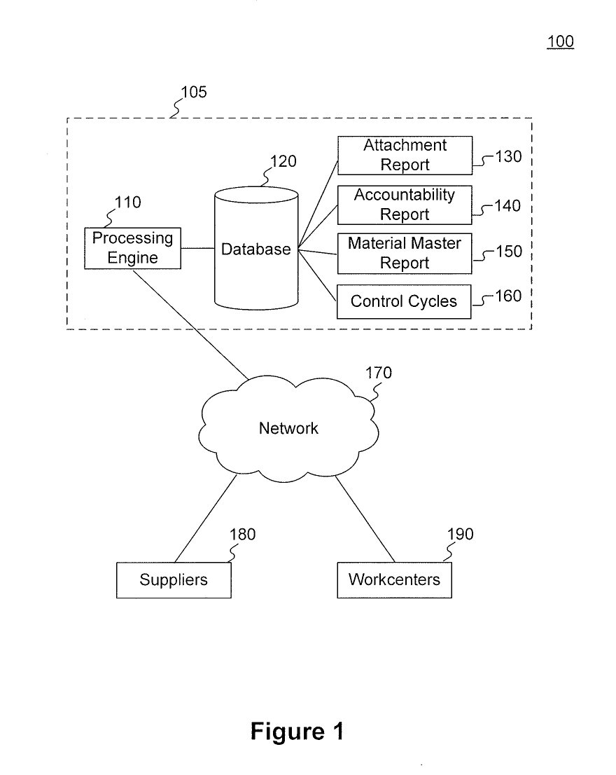

FIG. 1 depicts an exemplary system environment 100 for managing assembly accountability grief As shown in FIG. 1, system environment 100 includes a number of components. It will be appreciated from this disclosure that the number and arrangement of these components is exemplary and provided for purposes of illustration. Other arrangements and numbers of components may be utilized without departing from the teachings and embodiments of the present disclosure.

As shown in FIG. 1, the exemplary system environment 100 includes a system 105. System 105 may include one or more server systems, databases, and/or computing systems configured to receive information from entities over a network and process and/or store the information. In one embodiment, system 105 may include a processing engine 110 and one or more databases 120, which are illustrated in a region bounded by a dashed line for system 105 in FIG. 1.

In one embodiment, system 105 may transmit and/or receive data to/from various other components of system environment 100, such as one or more suppliers 180 and workcenters 190. More specifically, system 105 may be configured to receive and store data transmitted over an electronic network 170 (e.g., comprising the Internet) from various data sources, including suppliers 180 and workcenters 190, process and/or store the received data, and transmit the processed data over the electronic network to consumers of the data, which may include suppliers 180 and workcenters 190, among others.

The various components of system environment 100 may include an assembly of hardware, software, and/or firmware, including a memory, a central processing unit (“CPU”), and/or a user interface. Memory may include any type of RAM or ROM embodied in a non-transitory computer-readable storage medium, such as magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. Singular terms, such as “memory” and “computer-readable storage medium,” may additionally refer to multiple structures, such a plurality of memories and/or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals. A CPU may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

As described above, system 105 may be configured to receive data over electronic network 170 and store the data. For example, system 105 may receive data over electronic network 170 from suppliers 180, which may supply components of one or more manufacturing processes. For example, system 105 may receive information from suppliers 180 regarding components available for purchase from supplier 180, including component identifier, cost, lead time (i.e., expected time it takes to ship the component calculated from order date), and inventory (i.e., number of components currently available).

System 105 may also receive data over electronic network 170 from workcenters 190. Workcenters 190 may represent physical or logical subdivisions within one or more manufacturing facilities that are responsible for one or more stages of an assembly process. System 105 may receive information from workcenters 190 regarding the assembly of one or more machines, such as necessary parts (e.g., bill of materials (BOM)), current inventory, demand, routings, labor information (e.g., days assemblers are available to work on an assembly), and workcenter responsibilities (e.g., a description of a workcenter's responsibilities with respect to an assembly).

In one embodiment, system 105 may store data received over electronic network 170 from suppliers 180, workcenters 190, and other sources in one or more databases 120. In an alternate embodiment, system 105 may store data received over electronic network 170 from suppliers 180, workcenters 190, and other sources in other memory associated with processing engine 110, including local memory of processing engine 110 or remote storage (e.g., a remote server in communication with processing engine 110 (not shown)). Database 120 may be any suitable combination of large scale data storage devices, which may optionally include any type or combination of slave databases, load balancers, dummy servers, firewalls, back-up databases, and/or any other desired database components. For example, processing engine 110 may receive information regarding the cost, inventory, and lead time for components from suppliers 180 and store this information in database 120. Processing engine 110 may receive information regarding the assembly process, such as necessary components, inventory, demand, routings, labor information, and workcenter responsibilities, from workcenters 190 and store this information in database 120. Processing engine 110 may further associate the information received from suppliers 180 and workcenters 190 with various tables or components of database 120, such as attachment reports 130, accountability reports 140, material master report 150, and control cycles 160. For example, processing engine 110 may associate BOM, routing, demand and workcenter responsibility information received from workcenters 190 with attachment reports 130, accountability reports 140, and/or control cycles 160. Processing engine 110 may associate component supply information received from suppliers 180, such as component inventory (at the supplier), lead time, and cost, with material master report 150.

According to certain embodiments, database 120 stores attachment reports 130, accountability reports 140, material master report 150, and control cycles 160. Components 130-160 are used by system 105 to manage assembly accountability grief by analyzing, reporting, and assigning grief to responsible workcenters, according to one or more of the embodiments disclosed herein.

Attachment reports 130 may associate attachments with one or more models. An attachment is a subcomponent of an assembly comprising a plurality of individual components. An attachment, and each of its constituent components, may be associated with one or more sales models and/or engineering models. A sales model is a high-level model describing a product or product line produced by a manufacturer. An engineering model is a lower-level model that describes a more customized instantiation of a sales model. Moreover, several engineering models may correspond to the same sales model.

Accountability reports 140 may describe grief associated with one or more models. In one embodiment, an accountability report 140 may associate each sales model with one or more of four types of grief: underconsumption, overconsumption, invalid consumption, and broken consumption. Underconsumed inventory includes components that are not allocated to a routing. Accordingly, a component may be underconsumed if it is included in a bill of materials (and categorized as planning required) and/or in material master report 160, but it is not allocated to a workcenter and/or there is no operation associated with the component that would tell a workcenter how to utilize the component in the assembly of a model.

Overconsumed inventory includes any components that are allocated more than once in a routing. For example, if a component appears in a bill of materials for a model one time, then that component can only be allocated one time in a routing associated with that model. If the allocation of a component in the routing for a model exceeds the allocation of that component for the bill of materials for that model, then the component is overconsumed with respect to that model.

Invalid consumption describes instances in which a component is consumed incorrectly in a routing. For example, a supplier may supply a multipart attachment (e.g., a wheel assembly) as a complete attachment or in the form of separate components (e.g., a rim and a tire). If a workcenter 190 is required to install a multipart attachment in the manner it receives it from the supplier 180, but instead builds an attachment from the constituent parts (i.e., not as received from the supplier) and then installs the attachment, then the multipart attachment that should have been used and the constituent parts that were instead used in the assembly have been incorrectly consumed.

Broken consumption describes components that are improperly allocated for consumption in a routing. For example, if a manufacturer updates the bill of materials for a model to reflect a substitution of an old component for a new component, but does not update the routing for that model to reflect that substitution, then there is broken consumption of the old and new component with respect to that model.

Material master report 150 may include an inventory of all components in stock in a manufacturing facility along with certain information for each component. In one embodiment, material master report 150 includes, for each component, the number of units in stock, a cost of each unit, and an indication of whether the component is a high-value component. Control cycles 160 describe how components travel through a manufacturing facility, from the original receipt by the facility (e.g., at a loading dock) to consumption in the manufacturing process (e.g., at an assembly line within a workcenter).

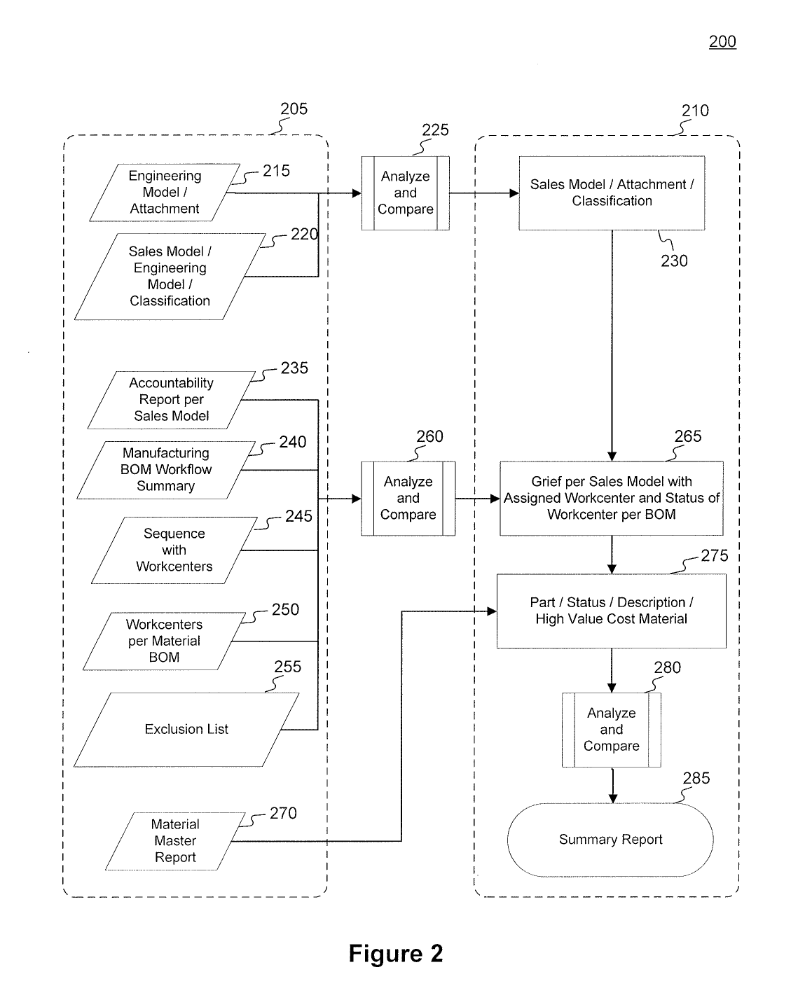

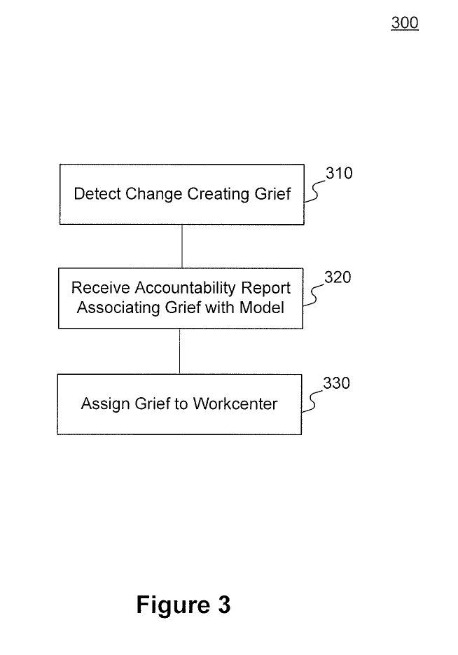

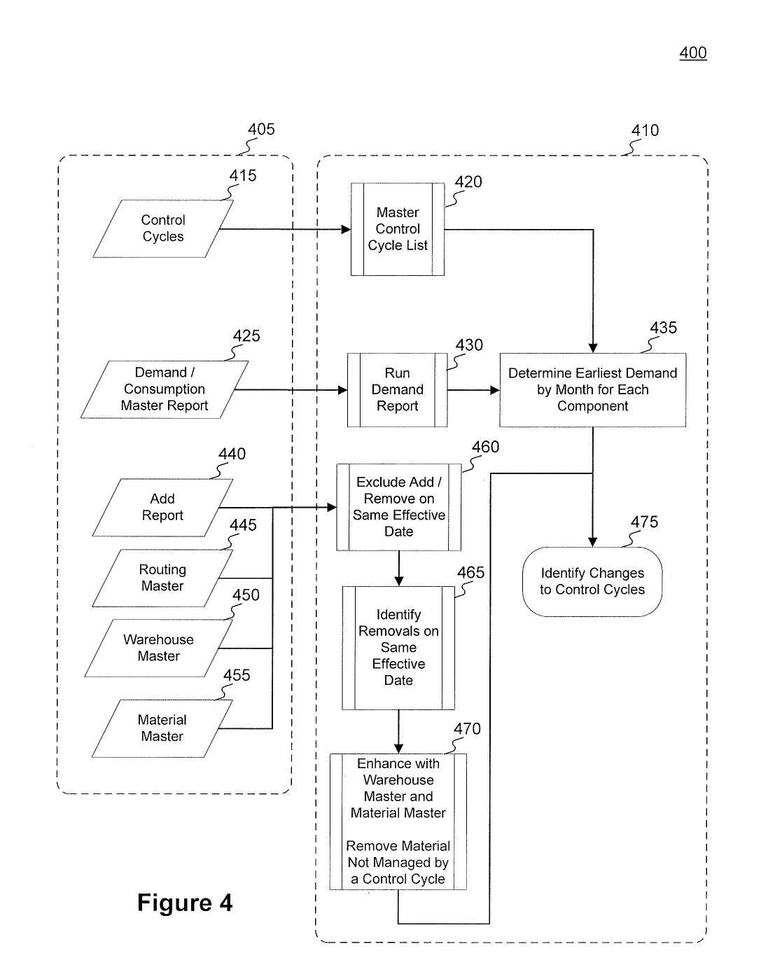

In accordance with certain embodiments, processing engine 110 detects changes to bills of materials that create grief. Processing engine 110 receives various reports and/or other information pertaining to the grief, such as attachment reports 130, accountability reports 140, and material master reports 150, and analyzes the information, such that it may be presented and/or assigned to workcenters 190 and other users (e.g., supply chain planning engineers). FIGS. 2 and 3, discussed below, provide further detail regarding techniques for managing assembly accountability grief by analyzing, reporting and assigning grief to responsible workcenters 190. FIG. 4, also discussed below, provides additional details regarding the creation and management of control cycles for new inventory, such as new inventory detected and assigned during the grief resolution process.

### INDUSTRIAL APPLICABILITY

The disclosed systems and methods for managing assembly accountability grief may be used to prevent holdup in the manufacturing process due to improper consumption of materials. In particular, the disclosed systems and methods may reduce holdup in the manufacturing process by detecting changes in bills of material that create grief, processing information related to the grief, and assigning the grief to the appropriate workcenters for resolution. The disclosed systems and methods further provide supply chain planning engineers and workcenters with information needed to resolve grief via comprehensive summary reports. By resolving grief quickly, manufacturers may ensure that components are allocated to the appropriate models and/or routings prior to the release of production orders.

Systems and methods are also disclosed for creation and management of control cycles for components in a manufacturing facility. These systems and methods enable manufacturers to identify the earliest required dates for components in the manufacturing process, so that components are delivered to the point of consumption no earlier or later than the time at which they are needed. Moreover, the disclosed systems and methods for managing control cycles for components also remove components from line-side if there is no demand for the components from the line, such as by sending those components to a warehouse, and remove components from a warehouse if there is no longer any demand for those components within an entire manufacturing facility. The disclosed systems and methods also remove control cycles for components that are no longer involved in the assembly of any product produced at a facility and de-allocate those components from all routings associated with the facility. Thus, the disclosed techniques for creation and management of control cycles ensure that inventory of components in a manufacturing facility accurately reflects the demands of the manufacturing processes associated with the facility, thus saving manufacturers storage space and cost.

FIG. 2 depicts an exemplary flow of a process 200 for managing assembly accountability grief by analyzing, reporting, and assigning grief to responsible workcenters, in accordance with an embodiment of the present disclosure. The steps associated with this exemplary process may be performed by the components of FIG. 1. For example, the steps associated with the exemplary process of FIG. 2 may be performed by processing engine 110 and/or database 120 of system 105 illustrated in FIG. 1.

The steps associated with process 200 may be performed using manufacturing resource planning (MRP) software, word processing software, spreadsheet software, and/or any other combination of software for storing, organizing, and presenting information related to manufacturing processes. The steps within region 205 generally relate to receipt or collection of data from MRP software, databases, or local files. The steps within region 210 generally relate to processing, analysis, and/or presentation of the collected data utilizing word processing and/or spreadsheet software, including scripting functionality.

In step 215, processing engine 110 may receive an attachment report. In one embodiment, the attachment report includes an inventory of attachments and associated engineering models. For example, the attachment report may include an inventory of every attachment used by a manufacturing facility, along with information associating each attachment with one or more engineering models in which the attachment is used. In step 220, processing engine 110 may receive a report that associates each engineering model with a sales model and a classification. As discussed above, each sales model may be associated with multiple engineering models, which may represent variations or customizations on a product or product line. The classification may indicate whether a sales or engineering model corresponds to a current production or a new product introduction.

In step 225, processing engine 110 analyzes and compares the information received in steps 215 and 220. Based on this analysis and comparison, the processing engine generates a comprehensive attachment report at step 230. In one embodiment, the comprehensive attachment report associates each attachment with a corresponding sales model and classification. Thus, the comprehensive attachment report includes an indication of every attachment associated with each sales model and whether each attachment is associated with a current production or a new product introduction.

Processing engine 110 receives an accountability report at step 235. The accountability report describes grief associated with sales models. As discussed above, the accountability report describes four types of grief that may be associated with a sales model: underconsumption, overconsumption, invalid consumption, and broken consumption. The accountability report may indicate how many instances of each type of grief are associated with each sales model.

At step 240, processing engine 110 receives a bill of materials (BOM) workflow summary, which associates workcenters in a manufacturer facility with tasks in a BOM, such as changes or modifications scheduled for a BOM in MRP software. Processing engine 110 receives a report associating a sequence of events in an assembly with responsible workcenters at step 245. At step 250, processing engine 110 receives a report associating workcenters with components in a bill of materials.

Processing engine 110 receives an exclusion list at step 255. In one embodiment, the exclusion list includes a list of components that should be excluded from consideration in the grief resolution process. Exemplary components that may be included on the exclusion list are fluids, liquids, paints, oils, and electronic/software groups. At step 260, processing engine 110 analyzes and compares the information received during steps 235-255. Based on this analysis and comparison, processing engine 110 generates a report at step 265 that associates grief per sales model with assigned workcenters for BOMs. In one embodiment, components on the exclusion list received at step 255 are excluded from the report generated in step 265.

In step 270, processing engine 110 receives a material master report 150, which may include an inventory of all components in a manufacturing facility. In addition to the identification of each component in a facility, the material master report may include additional information about each component, including number of units in inventory, cost per unit, and an indication of whether the unit is of high value. The information in material master report 150 is processed by processing engine 110 in step 275 to generate a report associating each component in the report with a status, description, and an indication of whether the component is a high value component.

The reports generated at steps 230, 265, and 275 are analyzed and compared at step 280. Based on this comparison and analysis, a summary report is generated at step 285. The summary report may indicate, for each component associated with grief, a sales model, responsible workcenter, classification, an indication of whether the component is a high-value component, and an indication of whether the component is included on the exclusion list. In one embodiment, components that are on the exclusion list are excluded from the summary report. The summary report may be used to assign grief to workcenters, so that grief related to a component is resolved prior to the time at which that component needs to be consumed in the assembly process, thus reducing downtime.

FIG. 3 depicts an exemplary flow of a process 300 for managing assembly accountability grief by analyzing, reporting, and assigning grief to responsible workcenters, in accordance with an embodiment of the present disclosure. The steps associated with this exemplary process may be performed by the components of Fig. I. For example, the steps associated with the exemplary process of FIG. 3 may be performed by processing engine 110 and/or database 120 of system 105 illustrated in FIG. 1.

In step 310, a change that creates at least one instance of grief is detected. The change may include a change to a bill of materials or a change to a process. In some embodiments, the at least one instance of grief is associated with a grief type selected from the group consisting of underconsumption, overconsumption, invalid consumption, and broken consumption. An accountability report associating the at least instance of one grief with an affected model is received in step 320. In one embodiment, the accountability report may be filtered based on an exclusion list. The exclusion list may comprise at least one component type. The component type may include, for example, fluids, liquids, paints, oils, and software.

In step 330, the at least one instance of grief is assigned to a workcenter. In one embodiment, assigning the at least one instance of grief to the workcenter includes assigning the at least one instance of grief to a worker associated with the workcenter. In one embodiment, a control cycle is created for a new component associated with the at least one instance of grief. The control cycle may comprise a plurality of locations associated with the new component.

In some embodiments, an attachment report and a material master report are received and used, along with the accountability report, to generate a summary report. The attachment report may comprise an inventory of attachments, wherein each attachment in the inventory of attachments is associated with a model and a classification. The material master report may comprise an inventory of components and a status, description, and value associated with each component in the inventory of components.

FIG. 4 depicts an exemplary flow of a process 400 for managing component control cycles, in accordance with an embodiment of the present disclosure. The steps associated with this exemplary process may be performed by the components of FIG. 1. For example, the steps associated with the exemplary process of FIG. 4 may be performed by processing engine 110 and/or database 120 of system 105 illustrated in FIG. 1.

The steps associated with process 400 may be performed using manufacturing resource planning (MRP) software, word processing software, spreadsheet software, and/or any other combination of software for storing, organizing, and presenting information related to manufacturing processes. The steps within region 405 generally relate to receipt or collection of data from MRP software, databases, or local files. The steps within region 410 generally relate to processing, analysis, and/or presentation of the collected data utilizing word processing and/or spreadsheet software, including scripting functionality.

In step 415, processing engine 110 receives a control cycle report, which may include an identification of every component in a manufacturing facility that is associated with a control cycle 160. For each component in the control cycle report, the report describes how the component travels through the factory, starting with the point at which the component is received by the manufacturer and ending with the point at which the component is consumed in the manufacturing process by a workcenter. Processing engine 110 processes and structures this report to generate a master control cycle list in step 420.

Processing engine 110 receives a demand/consumption master report in step 425. This report may include an identification of every component that has a demand within a manufacturing facility, as well as information regarding the models and/or routings with which the component is associated, and the time at the component is required for consumption in the manufacturing process. Processing engine runs this report in step 430. In step 435, processing engine uses the master control cycle report from step 420 and the demand report from step 430 to generate a report indicating the earliest demand by month for each component in step 435.

In step 440, processing engine 110 receives an add report, which indicates new materials that have been added to a workcenter without a control cycle. In step 445, processing engine 110 receives a routing master report, which describes how components are allocated to a sequence of events in the manufacturing process. In step 450, processing engine 110 receives a warehouse master report, which associates each component in a manufacturing facility with a bin location. In step 455, processing engine 110 receives a material master report 150.

In step 460, processing engine 110 processes the routing master report to exclude instances in which components were added/removed on the same effective date. Processing engine compares the add report to the routing master report to identify removals occurring on the same effective date in step 465. The report resulting from step 465 is enhanced with information from the warehouse master report and material master report to provide additional details related to storage and handling of components in step 470. Moreover, in step 470, components that are not managed by a control cycle are removed from the report.

In step 475, the reports generated in steps 435 and 470 are compared to identify potential changes to control cycles. New components are identified, such that a new control cycle may be created for those components. Components located at line-side, but for which there is no current demand at the line, are identified and moved from line-side to a warehouse. Components that are no longer used for any manufacturing process are identified and de-allocated from all routings, and any control cycle associated with those components is cancelled to prevent future orders of unneeded components. Material located in a warehouse, but for which there is no demand within an entire manufacturing facility or process, is identified, such that it may be removed from the warehouse. These actions ensure optimal utilization of manufacturing space, thus saving manufacturers storage space and costs.

Several advantages over the prior art may be associated with the disclosed systems and methods for managing assembly accountability grief and the disclosed systems and methods for managing component control cycles. Grief, and components associated therewith, may be assigned to appropriate workcenters efficiently to minimize holdup in manufacturing processes. Moreover, detailed summary reports are provided, so that grief may be resolved quickly, without reference to multiple disjointed sets of data. Further, manufacturing facility space is conserved by removing unneeded components from a line or warehouse and ensuring that all component control cycles are up-to-date.

It will be apparent to those skilled in the art that various modifications and variations can be made to the disclosed systems and methods for managing assembly accountability grief. Other embodiments will be apparent to those skilled in the art from consideration of the specification and practice of the disclosed systems and methods for managing assembly accountability grief. It is intended that the specification and examples be considered as exemplary only, with a true scope being indicated by the following claims and their equivalents.

What is claimed is:

1. A system for managing assembly accountability grief, comprising:
a memory that stores a set of instructions; and
at least one processor in communication with the memory and configured to execute the set of instructions to:
detect a change, wherein the detected change creates at least one grief;
receive an accountability report associating the at least one grief with an affected model; and
assign the at least one grief to a workcenter.

2. The system of claim 1, wherein the at least one grief is associated with a grief type selected from the group consisting of underconsumption, overconsumption, invalid consumption, and broken consumption.

3. The system of claim 2, wherein underconsumption includes at least one component that is not allocated to a routing.

4. The system of claim 2, wherein overconsumption includes at least one component that is allocated more than once in a routing.

5. The system of claim 2, wherein invalid consumption includes at least one component that is consumed incorrectly in a routing.

6. The system of claim 2, wherein broken consumption includes at least one component that is improperly allocated for consumption in a routing.

7. The system of claim 1, wherein the processor is further configured to filter the accountability report based on an exclusion list.

8. The system of claim 7, wherein the exclusion list includes at least one component type associated with a grief.

9. The system of claim 1, wherein the processor is configured to assign the at least one grief to the workcenter by assigning the at least one grief to a worker associated with the workcenter.

10. The system of claim 1, wherein the processor is further configured to create a control cycle for a new component associated with the at least one grief.

11. The system of claim 10, wherein the control cycle includes a plurality of locations associated with the new component.

12. The system of claim 1, wherein the processor is further configured to:
receive an attachment report comprising an inventory of attachments, wherein each attachment in the inventory of attachments is associated with a model and a classification;
receive a material master report comprising an inventory of components and a status, description, and value associated with each component in the inventory of components; and
generate a summary report based on the accountability report, the attachment report, and the material master report.

13. A non-transitory computer-readable storage medium storing instructions for managing assembly accountability grief, the instructions causing at least one processor to perform operations comprising:
detecting a change, wherein the detected change creates at least one grief;
receiving an accountability report associating the at least one grief with an affected model; and
assigning the at least one grief to a workcenter.

14. The non-transitory computer-readable storage medium of claim 13, wherein the at least one grief is associated with a grief type selected from the group consisting of underconsumption, overconsumption, invalid consumption, and broken consumption.

15. The non-transitory computer-readable storage medium of claim 13, wherein the instructions further cause the at least one processor to filter the accountability report based on an exclusion list.

16. The non-transitory computer-readable storage medium of claim 15, wherein the exclusion list includes at least one component type associated with a grief.

17. The non-transitory computer-readable storage medium of claim 13, wherein the processor is configured to assign the at least one grief to the workcenter by assigning the at least one grief to a worker associated with the workcenter.

18. The non-transitory computer-readable storage medium of claim 13, wherein the instructions further cause the at least one processor to create a control cycle for a new component associated with the at least one grief.

19. The system of claim 18, wherein the control cycle includes a plurality of locations associated with the new component.

20. The non-transitory computer-readable storage medium of claim 13, wherein the instructions further cause the at least one processor to:
receive an attachment report comprising an inventory of attachments, wherein each attachment in the inventory of attachments is associated with a model and a classification;
receive a material master report comprising an inventory of components and a status, description, and value associated with each component in the inventory of components; and
generate a summary report based on the accountability report, the attachment report, and the material master report.
